(19) United States
(12) Patent Application Publication
(10) Pub. No.: US 2026/0155943 A1
(43) Pub. Date: Jun. 4, 2026

(54) APPARATUS, METHOD, AND COMPUTER PROGRAM

(71) Applicant: NOKIA TECHNOLOGIES OY, Espoo (FI)

(72) Inventors: Oskari TERVO, Oulu (FI); Ismael PERUGA NASARRE, Tampere (FI); Majed SAAD, Nozay (FR); Le-Hang NGUYEN, Gerlingen (DE); Arto LEHTI, Anthony (FR)

(73) Assignee: NOKIA TECHNOLOGIES OY, Espoo (FI)

(21) Appl. No.: 19/123,804

(22) PCT Filed: Oct. 28, 2022
(86) PCT No.: PCT/EP2022/080266

§ 371 Date: Apr. 24, 2025

(51) Int. Cl. H04L 5/00; H04L 1/20

(52) U.S. Cl. CPC H04L 5/0091; H04L 1/206

(57) ABSTRACT

The disclosure relates to an apparatus comprising at least one processor and at least one memory including computer code for one or more programs, the at least one memory and the computer code configured, with the at least one processor, to cause the apparatus at least to: send (1700), to a network node, a radio frequency impairment indication; and receive (1702), from the network node, a physical downlink control channel with a physical downlink control channel configuration determined based on the radio frequency impairment indication.

### FIELD OF THE DISCLOSURE

The present disclosure relates to an apparatus, a method, and a computer program for sending and receiving a physical downlink control channel in a communication system.

For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically configured. Examples of standard are the so-called 5G standards.

### SUMMARY

According to an aspect there is provided an apparatus comprising at least one processor and at least one memory including computer code for one or more programs, the at least one memory and the computer code configured, with the at least one processor, to cause the apparatus at least to: send, to a network node, a radio frequency impairment indication; and receive, from the network node, a physical downlink control channel with a physical downlink control channel configuration determined based on the radio frequency impairment indication.

The at least one memory and the computer code may be configured, with the at least one processor, to cause the apparatus at least to: monitor, a physical downlink control channel with a physical downlink control channel configuration determined based on the radio frequency impairment indication.

The at least one memory and the computer code may be configured, with the at least one processor, to cause the apparatus at least to: blindly monitor, a physical downlink control channel with different physical downlink control channel configurations.

The network node may be a base station.

The radio frequency impairment indication may explicitly indicate a radio frequency impairment class.

The radio frequency impairment indication may depend on a severity of a radio frequency impairment.

The severity of a radio frequency impairment at the apparatus may comprises at least one of: a high radio frequency impairment; a medium radio frequency impairment; or a low radio frequency impairment.

The radio frequency impairment indication may depend on a type of a radio frequency impairment.

The type of a radio frequency impairment at the apparatus may comprise at least one of: a phase noise impairment; a quantization impairment; a in phase and quadrature imbalance impairment; a power amplifier non-linearity, a time jitter; or a carrier frequency offset.

The radio frequency impairment indication may depend on a subtype of a radio frequency impairment at the user equipment.

The radio frequency impairment indication may implicitly indicate a radio frequency impairment class assigned to the apparatus.

The radio frequency impairment indication may comprise at least one of: a desired reference signal configuration by the apparatus; a quality of a local oscillator at the apparatus; a resolution of an analogue to digital converter at the apparatus; or a physical random access channel preamble used by the apparatus in an initial access phase.

The radio frequency impairment indication may be sent via at least one of: capability information signaling; physical random access channel signaling; or radio resource control signaling.

The desired reference signal configuration may comprise a desired phase tracking reference signal configuration.

The radio frequency impairment indication may be specific to at least one of a bandwidth, a subcarrier spacing or a frequency carrier used by the apparatus.

Determining the physical downlink control channel configuration by the apparatus may comprise determining at least one of: a reference signal configuration; a subcarrier spacing configuration; an aggregation level configuration; a control channel element configuration; a resource element group configuration; a resource element group bundle configuration; a modulation scheme configuration; or a code rate configuration.

The reference signal configuration comprises a number of reference signal symbols.

Determining the reference signal configuration may comprise determining at least one of: a pattern of the reference signal symbols; or a transmission power of the reference signal symbols.

Determining the pattern of the reference signal symbols comprises: determining a contiguous pattern wherein the reference signal symbols span over multiple contiguous blocks; or determining a non-contiguous pattern wherein the reference signal symbols span over multiple non-contiguous blocks.

Determining the reference signal configuration may comprise determining the reference signal configuration over: a control channel element or multiple control channel elements; a resource element group or multiple resource element groups; or a block or multiple blocks.

Determining the reference signal configuration may comprise determining at least one of: a phase tracking reference signal configuration; or a demodulation reference signal configuration.

Determining the reference signal configuration may be based on at least one of: an aggregation level used by the apparatus; a coding rate used by the apparatus; or a waveform used for sending the physical downlink control channel by the apparatus.

The lower the aggregation level may be, the higher the number of reference signal symbols may be.

The lower the aggregation level may be, the higher the transmission power of the reference signal symbols may be.

The waveform used for sending the physical downlink control channel may comprise a single-carrier waveform or a multiple-carrier waveform.

A single-carrier waveform may be provided by at least one of: a discrete Fourier transform spread orthogonal frequency division multiplexing system; a known tail discrete Fourier transform spread orthogonal frequency division multiplexing system; a single carrier frequency domain equalization system; a single carrier time domain equalization system.

A multiple-carrier waveform may be provided by a cyclic prefix orthogonal frequency division multiplexing system.

Determining the aggregation level configuration comprises determining a minimum aggregation level.

The higher the coding rate (i.e. the lower the aggregation level) may be, the more detrimental the radio frequency impairment may be. Therefore, the aggregation level may be equal to or greater than the minimum aggregation level to mitigate the radio frequency impairment.

The physical downlink control channel configuration may be determined by the apparatus based on the radio frequency impairment indication; or the physical downlink control channel configuration may be determined by the network node based on the radio frequency impairment indication and received by the apparatus from the network node

According to an aspect there is provided an apparatus comprising means for: sending, to a network node, a radio frequency impairment indication; and receiving, from the network node, a physical downlink control channel with a physical downlink control channel configuration determined based on the radio frequency impairment indication.

According to an aspect there is provided an apparatus comprising circuitry configured to: send, to a network node, a radio frequency impairment indication; and receive, from the network node, a physical downlink control channel with a physical downlink control channel configuration determined based on the radio frequency impairment indication.

According to an aspect there is provided a method comprising: sending, to a network node, a radio frequency impairment indication; and receiving, from the network node, a physical downlink control channel with a physical downlink control channel configuration determined based on the radio frequency impairment indication.

According to an aspect there is provided a computer program comprising computer executable code which when run on at least one processor is configured to: send, to a network node, a radio frequency impairment indication; and receive, from the network node, a physical downlink control channel with a physical downlink control channel configuration determined based on the radio frequency impairment indication.

According to an aspect there is provided an apparatus comprising at least one processor and at least one memory including computer code for one or more programs, the at least one memory and the computer code configured, with the at least one processor, to cause the apparatus at least to: receive, from a user equipment, a radio frequency impairment indication; determine a physical downlink control channel configuration based on the radio frequency impairment indication; and send, to the user equipment, the physical downlink control channel with the physical downlink control channel configuration.

According to an aspect there is provided an apparatus comprising means for: receiving, from a user equipment, a radio frequency impairment indication; determining a physical downlink control channel configuration based on the radio frequency impairment indication; and sending, to the user equipment, the physical downlink control channel with the physical downlink control channel configuration.

According to an aspect there is provided an apparatus comprising circuitry configured to: receive, from a user equipment, a radio frequency impairment indication; determine a physical downlink control channel configuration based on the radio frequency impairment indication; and send, to the user equipment, the physical downlink control channel with the physical downlink control channel configuration.

According to an aspect there is provided a method comprising: receiving, from a user equipment, a radio frequency impairment indication; determining a physical downlink control channel configuration based on the radio frequency impairment indication; and sending, to the user equipment, the physical downlink control channel with the physical downlink control channel configuration.

According to an aspect there is provided a computer program comprising computer executable code which when run on at least one processor is configured to: receive, from a user equipment, a radio frequency impairment indication; determine a physical downlink control channel configuration based on the radio frequency impairment indication; and send, to the user equipment, the physical downlink control channel with the physical downlink control channel configuration.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AL: Aggregation Level
AMF: Access and Mobility Management Function
API: Application Programming Interface
BS: Base Station
CCE: Control Channel Element
CEPT: European Conference of Postal and Telecommunications
CU: Centralized Unit
CP-OFDM: Cyclic Prefix Orthogonal Frequency Division Multiplexing
DCI: Downlink Control Information
DL: Downlink
DMRS: Demodulation Reference Signal
DU: Distributed Unit
ECC: Electronics Communication Committee
EIRP: Equivalent Isotropic Radiated Power
gNB: gNodeB
GSM: Global System for Mobile communication
HSS: Home Subscriber Server
ICI: Intercarrier Interference
IoT: Internet of Things
(KT) DFT-s-OFDM: (Known Tail) Discrete Fourier Transform Spread Orthogonal Frequency Division Multiplexing
LTE: Long Term Evolution
MAC: Medium Access Control
MCS: Modulation and Coding Scheme
MS: Mobile Station
MTC: Machine Type Communication
NEF: Network Exposure Function
NF: Network Function
NR: New radio
NRF: Network Repository Function
OBO: Output Power Backoff
OFDM: Orthogonal Frequency Division Multiplexing
PDCCH: Physical Downlink Control Channel
PDU: Packet Data Unit
PN: Phase Noise
PT-RS: Phase Tracking Reference Signal
RAM: Random Access Memory
(R)AN: (Radio) Access Network
RE: Resource Element
REG: Resource Element Group
RF: Radio Frequency
ROM: Read Only Memory
RS: Reference Signal
SCS: Subcarrier Spacing
SC-FDE: Single Carrier Frequency Domain Equalization
SC-TDE: Single Carrier Time Domain Equalization
SMF: Session Management Function
TR: Technical Report
TS: Technical Specification
UE: User Equipment
UL: Uplink
UMTS: Universal Mobile Telecommunication System
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a legacy 5G system;

FIG. 2 shows a schematic representation of a control apparatus;

FIG. 3 shows a schematic representation of a user equipment;

FIG. 4 shows a schematic representation of a transmission chain of a cyclic prefix orthogonal frequency division multiplexing system;

FIG. 5 shows a schematic representation of a transmission chain of a discrete Fourier transform spread orthogonal frequency division multiplexing system;

FIG. 6 shows a schematic representation of a transmission chain of a single carrier frequency domain equalization system;

FIG. 7 shows a schematic representation of a control channel element to resource element group mapping of a physical downlink control channel in a legacy 5G system;

FIG. 8 shows a table 7.3.2.1-1 of 3GPP TS 38.211 specifying the relationship between an aggregation level and a number of control channel elements of a physical downlink control channel in a legacy 5G system;

FIG. 9 shows a table specifying the relationship between an aggregation level, a number of control channel elements, a number of resource element groups, a number of resource elements, a number of phase tracking reference signal resource elements, a number of demodulation reference signal resource elements, a number of coded control data resource elements and a total number of bits for the coded control data of a physical downlink control channel in a legacy 5G system;

FIG. 10 shows a table 5.1.6.3-1 and a table 5.1.6.3-2 of TS 38.214 defining phase tracking reference signal patterns for a physical uplink shared channel in a legacy 5G system when transform precoding is disabled (cyclic prefix orthogonal division multiplexing);

FIG. 11 shows a table 6.2.3.2-1 of TS 38.214 defining phase tracking reference signal patterns for a physical uplink shared channel in a legacy 5G system when transform precoding is enabled (discrete Fourier transform spread orthogonal division multiplexing);

FIG. 12 shows examples of different control channel element configurations when a physical downlink control channel would be sent using a single-carrier waveform;

FIG. 13 shows a table specifying the relationship between an aggregation level, a number of control channel element, a number of resource element groups, a number of resource elements, a number of phase tracking reference signal resource elements, a number of demodulation reference signal resource elements, a number of coded control data resource elements and a total number of bits for the coded control data of a physical downlink control channel;

FIG. 14 shows different time-domain phase tracking reference signal configurations with different patterns and a same or different number of phase tracking reference signal symbols for a physical downlink control channel based on different radio frequency impairment indications from a user equipment;

FIG. 15 shows different phase tracking reference signal configurations with different number of phase tracking reference signal symbols for a physical downlink control channel (when aggregation level is 16) based on different radio frequency impairment indications from a user equipment and a required estimation accuracy;

FIG. 16 shows example phase tracking reference signal configuration and demultiplexing reference signal configurations for a control channel element occupying one or two orthogonal frequency division multiplexing symbols;

FIG. 17 shows a block diagram of a method for receiving a physical control channel performed by a user equipment;

FIG. 18 shows a block diagram of a method for sending a physical control channel performed by a network node; and

FIG. 19 shows a schematic representation of a non-volatile memory medium storing instructions which when executed by a processor allow a processor to perform one or more of the steps of the methods of FIGS. 17 and 18.

### DETAILED DESCRIPTION OF THE FIGURES

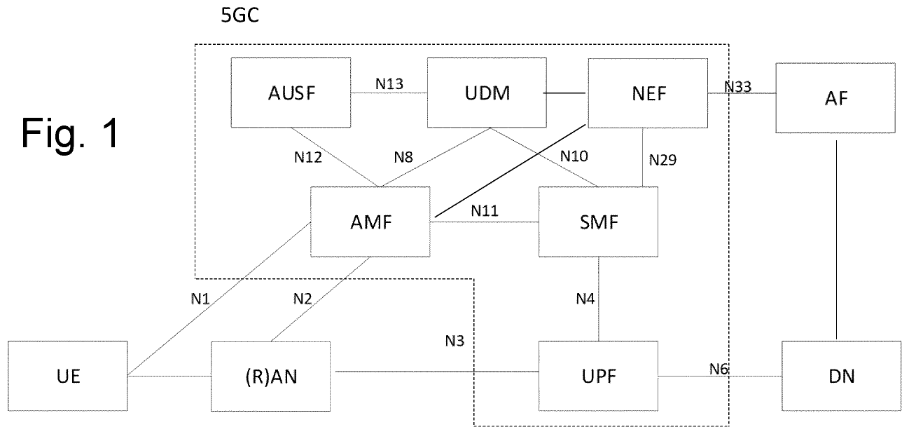

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a legacy 5G system (5GS). The 5GS may comprises a user equipment (UE), a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise an access and mobility management function (AMF), a session management function (SMF), an authentication server function (AUSF), a user data management (UDM), a user plane function (UPF) and/or a network exposure function (NEF).

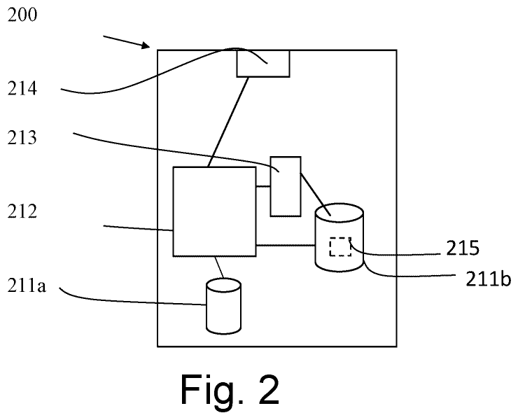

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects.

The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

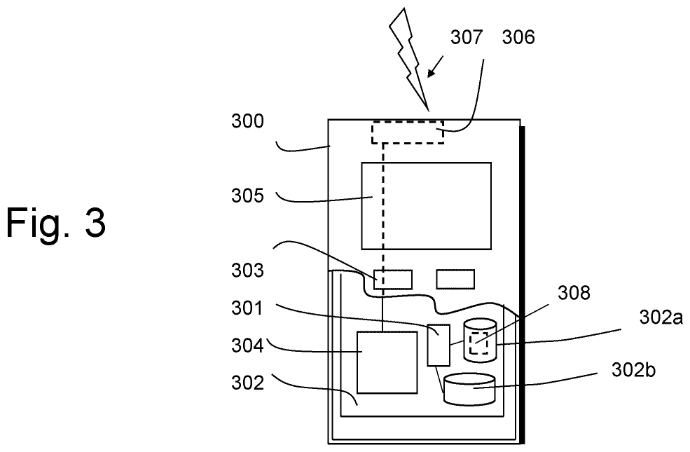

FIG. 3 illustrates an example of a UE 300, such as the UE illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more aspects of this disclosure relates to sending a physical downlink control channel (PDCCH) from a BS to a UE. The PDCCH may schedule downlink (DL) transmission to the UE and/or uplink (UL) transmissions from the UE.

One or more aspects of this disclosure relates to sending a physical downlink control channel (PDCCH) from a BS to a UE when the UE experiences a RF impairment. A UE may experience a significant RF impairment for example when the BS and UE operate in sub-THz frequency bands (e.g. frequency bands above 71 GHZ).

In NR Release 18 workshop and in the following email discussion prior to RAN #93-e it has been discussed using a single-carrier waveform both in uplink (UL) and downlink (DL) and operating in sub-THz frequency bands. This was eventually not implemented in NR Release 18 and was postponed to NR Release 19 or beyond.

A single-carrier waveform may be provided by a discrete Fourier transform (with or without known tail) spread orthogonal frequency division multiplexing ((KT) DFT-s-OFDM) system, a single carrier frequency domain equalization (SC-FDE) system, a single carrier time domain equalization (SC-TDE). In DFT-s-OFDM, each DFT-s-OFDM symbol may be prepended with cyclic prefix, while in KT-DFT-s-OFDM (also known as unique word DFT-s-OFDM), there may be no cyclic prefix, but there may be a known sequence(s) of pre-defined length(s) inserted in the beginning (head) and/or end (tail) of each symbol, prior to the DFT operation at the transmitter. By contrast, a multiple-carrier waveform may be provided by a cyclic prefix orthogonal frequency division multiplexing (CP-OFDM) system.

A legacy 5GS uses a multiple-carrier waveform provided by a CP-OFDM system on the DL and a multiple-carrier waveform provided by a CP-OFDM system or a single-carrier waveform provided by a DFT-s-OFDM on the UL.

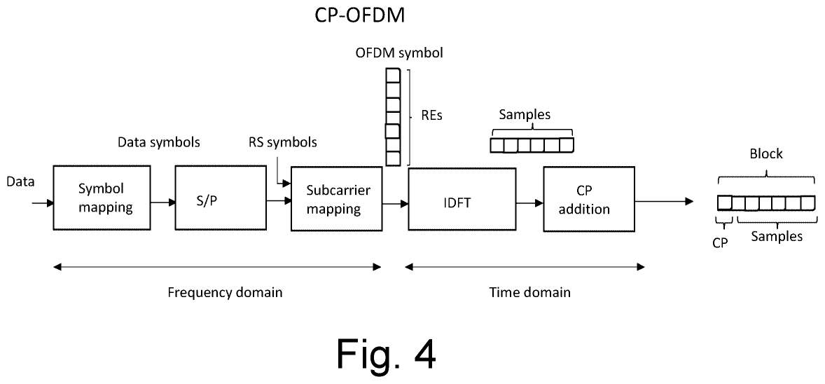

FIG. 4 shows a schematic representation of a transmission chain of a CP-OFDM system. The operation of a CP-OFDM system is well known and therefore not described in details.

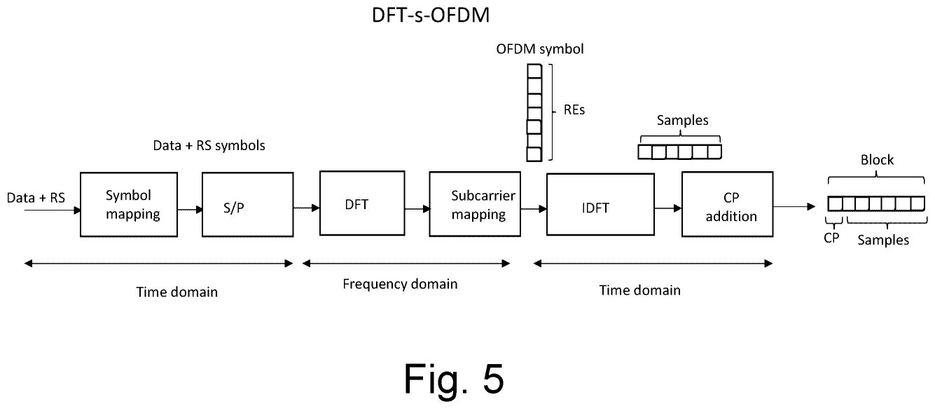

FIG. 5 shows a schematic representation of a transmission chain of a DFT-s-OFDM system. The operation of a DFT-s-OFDM system is well known and therefore not described in details.

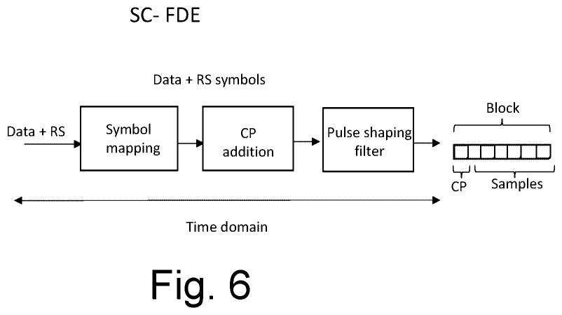

FIG. 6 shows a schematic representation of a transmission chain of a SC-FDE system. The operation of a SC-FDE system is well known and therefore not described in details.

A single-carrier waveform may achieve a higher equivalent isotropic radiated power (EIRP) (e.g. 60 dBm) with a smaller power amplifier output power backoff (OBO) than a multiple-carrier waveform. Thus, a single-carrier waveform may reduce cost and complexity of the hardware as well as power consumption compared to a multiple-carrier waveform. Moreover, a single-carrier waveform may be more robust to phase noise (PN) with lower complexity than a multiple-carrier waveform.

A frequency spectrum comprising sub-THz frequency bands is large but comprise various usage restrictions, such as RR5.340 where all communications are prohibited (passive satellite band). The sub-THz frequency bands include a W-band (75 to 110 GHZ), a D-band (110 to 170 GHZ) and other bands up to THz frequencies.

European telecommunications regulator European Conference of Postal and Telecommunications (CEPT) Electronics Communication Committee (ECC) has approved two recommendations for fixed service (FS) above 92 GHz:
W Band ECC Recommendation ECC/REC/(18)02 on frequencies 92-114.25 GHZ (link); and
D Band ECC Recommendation ECC/REC/(18)01 on frequencies 130-174.8 GHZ (link).

The W-band was considered as a possibility for operation in sub-THz frequency bands in NR Release 18 discussion. However, as discussed above, operation in sub-THz frequency bands was postponed to NR Release 19 or beyond.

PDCCH may be used to carry downlink control information (DCI), occupying a specific number of resource elements according to its aggregation level, which is quantified in terms of control channel elements (CCEs) it occupies. The PDCCH may be transmitted in a control resource set (CORESET), which is a set of time/frequency resources where PDCCH may be transmitted, and based on that the UE knows the locations where to try reception of PDCCH. Based on the CORESET and search space, a UE may try to blindly decode PDCCH from certain locations and using certain aggregation levels. The CORESET may comprise a certain number of CCEs. CCEs may comprise a certain number of REGs.

When operating in the higher millimetre wave bands and sub-THz frequency bands, a phase noise (PN) experienced by a UE may become increasingly important, if not the limiting factor. When operating in the sub-THz frequency bands, a BS may send a PDCCH to the UE comprising a phase tracking reference signal (PT-RS) to allow the UE to mitigate the impact of the PN. However, as a legacy 5GS operates currently in the lower frequency bands, the PN experienced by a UE is not that important and the BS does not send a PDCCH comprising a PT-RS.

Future systems may be tailored to account for different RF impairments at a UE. RF impairments may, for example, include a PN experienced by the UE or a quantization error experienced by the UE. RF impairments may be implementation dependent. That is, each UE may have a specific implementation and therefore may experience a specific RF impairment.

A power amplifier power consumption increases with larger bandwidth as in the sub-THz frequency bands and with higher peak-to-average power ratio waveform and larger OBO due to the operation at low power amplifier efficiency zone for better linearity.

An analogue to digital converter power consumption increases with the sampling rate (with the bandwidth) and also with the number of quantization levels (resolution bits). For that reason, a lower analogue to digital resolution when operating in the sub-THz frequency bands may be preferred to counterbalance the power increase with multiple input multiple output and larger bandwidth which may be unavoidable.

The available bandwidth in the frequency spectrum comprising the sub-THz frequency bands is large and therefore it may make sense to reduce energy consumption at the expense of spectral efficiency. For example, a UE may use a low-resolution analogue to digital converter and low order modulations.

Assuming the use of such low-resolution analogue to digital converter, taking into consideration the RF impairment at the UE may become important when sending a PDCCH from a BS to a UE.

The PN experienced by a UE may originate from local oscillators in the up and down conversion. Usually in an OFDM based systems (e.g. CP-OFDM or (KT) DFT-s-OFDM systems) the impact of PN may comprise a common phase error which may be common for all subcarriers. The impact of PN may comprise an inter carrier interference (ICI) which may be unique for each subcarrier. The impact of PN may depend on a subcarrier spacing (SCS). The spectrum of the PN may typically have a certain shape which depends highly on the implementation.

The PN may be modelled as a combination of a Wiener component and Gaussian component. A threshold for the dominant component can be approximated based on the condition (1) below (see S. Bicais and J.-B. Dore, “Phase Noise Model Selection for Sub-THz Communications,” 2019 IEEE Global Communications Conference (GLOBECOM), 2019, pp. 1-6, doi: 10.1109/GLOBECOM38437.2019.9013189).

$$N \cdot {f}_{c}^{2} \cdot {T}^{2} \leq \frac{ln ( 2 )}{2 {π}^{2}} \qquad ( 1 )$$

N may be the number of symbols per frame.
fc may be an oscillator corner frequency.
T may be a symbol period (i.e. inverse of system bandwidth).

If the condition (2) below is met, the dominant component may be the Gaussian component. That is, the Gaussian component may be greater than the Wiener component.

$$N \cdot {f}_{c}^{2} \cdot {T}^{2} < \frac{ln ( 2 )}{2 {π}^{2}} \qquad ( 2 )$$

If the condition (3) below is met, the dominant component may be the Wiener component. That is, the Wiener component may be greater than the Gaussian component.

$$N \cdot {f}_{c}^{2} \cdot {T}^{2} > \frac{ln ( 2 )}{2 {π}^{2}} \qquad ( 3 )$$

If the condition below (4) is met, there may be no dominant component. That is, the Wiener component may be substantially equal to the Gaussian component.

$$N \cdot {f}_{c}^{2} \cdot {T}^{2} \approx \frac{ln ( 2 )}{2 {π}^{2}} \qquad ( 4 )$$

When operating in the sub-THz frequency bands, a RF impairment may increase as a function of the frequency band. The higher the frequency band may be, the higher the RF impairment may be. The RF impairment may be taken into account when sending a PDCCH from a BS to a UE to ensure robust and reliable reception by the UE.

Similarly, when operating in the sub-THz frequency bands, a transmitter impairment may increase as a function of the frequency band. The higher the frequency band may be, the higher the transmitter impairment may be. The transmitter impairment may be taken into account when sending a PDCCH from a BS to a UE ensure robust and reliable reception by the UE.

As explained above, in a legacy 5GS the BS may not send a PDCCH comprising a PT-RS or another reference signal (RS) which has a definable configuration per resource element group (REG). The BS may send a PDCCH comprising a demodulation reference signal (DMRS). Each control channel element (CCE) may comprise DMRS resource elements (REs). The DMRS has a fixed configuration per REG. The phase noise may be equalized from DMRS channel estimation.

When operating in the sub-THz frequency bands, a RF impairment at the UE may become significantly more challenging and highly implementation dependent. This means that the PDCCH framework used in a legacy 5GS may not be efficient and reliable.

In 5G FR2-2 (52.6-71 GHZ), NR Release 17 reused large part of the specification from lower frequencies 5G FR2-1 because the frequency increase and time budget for specification was quite low.

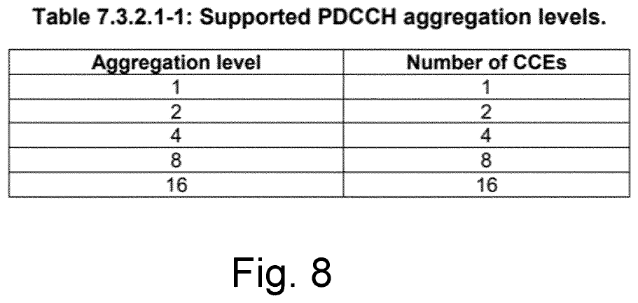

In a legacy 5GS a PDCCH configuration may be defined in the frequency domain in a resource grid. The resource grid may comprise OFDM symbols. A PDCCH may comprise an aggregation level (AL). The AL may comprise a number of CCEs. There may be direct relationship between the AL and the number of CCEs. That is, an AL N may comprise N CCEs. Each CCE may comprise 6 REGs. Each REG may comprise 12 REs. The CCE to REG mapping may depend on the number of OFDM symbols the PDCCH occupies. The number of OFDM symbols the PDCCH occupies may be 1, 2 or 3 as in the example of FIG. 8.

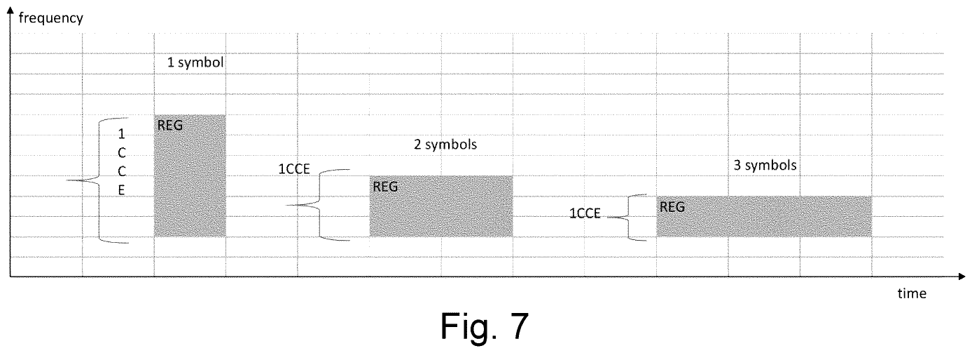

FIG. 7 shows a schematic representation example of a CCE to REG mapping of a PDCCH in a legacy 5GS. Each column represents an OFDM symbol. Each cell represents a REG.

FIG. 8 shows a table 7.3.2.1-1 of 3GPP TS 38.211 specifying the relationship between an AL and a number of CCEs of a PDCCH in a legacy 5GS.

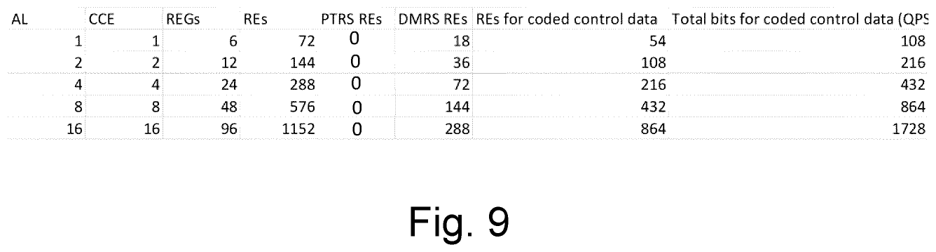

FIG. 9 shows a table specifying the relationship between an AL, a number of CCEs, a number of REGs, a number of PT-RS REs, a number of DMRS REs, a number of coded control data (i.e. downlink control information (DCI)) REs and a total number of bits for the coded control data of a PDCCH in a legacy 5GS. Each control channel element (CCE) may comprise DMRS REs. The DMRS has a fixed configuration per REG.

As illustrated in FIG. 9, in a legacy 5GS the BS does not send a PDCCH comprising a PT-RS (i.e. the number of PT-RS REs is equal to zero). At most, the BS may send a PDSCH comprising a PT-RS and/or the UE may send a PUSCH comprising a PT-RS. One or more aspects of this disclosure configure the BS to send PDCCH comprising a PT-RS.

When operating in the sub-THz frequency bands, a single-carrier waveform may be used to send the PDCCH to the UE. A single-carrier waveform may be provided using a (KT) DFT-S-OFDM system, a SC-FDE system or a SC-TDE. When using a single-carrier waveform, control data (i.e. DCI) symbols may be multiplexed with DMRS symbols in the time domain. The DMRS symbols may be used by the UE to perform frequency domain channel estimation. The control data (i.e. DCI) symbols may be altered by the PN experienced by the UE.

In a legacy 5GS the BS may send a physical downlink shared channel (PDSCH) using a CP-OFDM system and a physical uplink shared channel (PUSCH) using a CP-OFDM system or a DFT-s-OFDM system. The PDSCH and PUSCH may comprise a PT-RS.

Different PT-RS patterns may be defined in the frequency domain for a CP-OFDM system. For example, in legacy 5GS, the PT-RS pattern may comprise a comb-pattern distributed over the transmission bandwidth with different densities when PDSCH or PUSCH is transmitted. In the future, the PT-RS patterns could also comprise a contiguous pattern (also called block pattern) wherein the PT-RS is conveyed over multiple contiguous subcarriers. This may enable efficient ICI compensation at the UE. Different PT-RS patterns may be defined in the time domain for a DFT-s-OFDM system. These PT-RS patterns may improve PN mitigation at the receiver side.

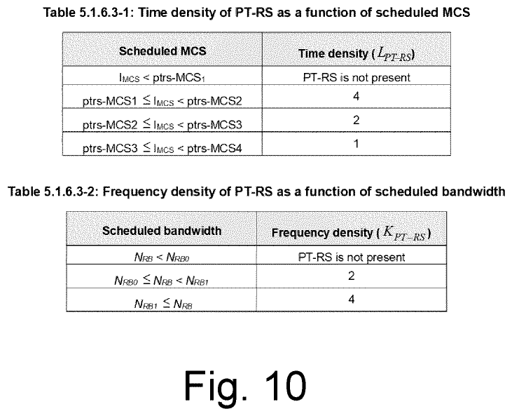

FIG. 10 shows a table 5.1.6.3-1 of TS 38.214 defining different PT-RS patterns for PUSCH using a CP-OFDM system in legacy 5GS.

FIG. 10 shows a table 5.1.6.3-2 of TS 38.214 defining different PT-RS patterns for PUSCH using a CP-OFDM system in legacy 5GS.

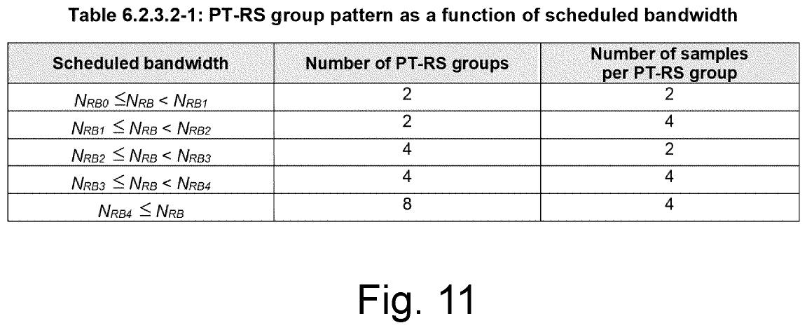

FIG. 11 shows a table 6.2.3.2-1 of TS 38.214 defining different phase tracking reference signal pattern for a PUSCH using a DFT-s-OFDM system in legacy 5GS.

One or more aspects of this disclosure provide a mechanism to allow a BS to define a PDCCH configuration based on a radio frequency (RF) impairment indication. The RF impairment indication may be determined by the UE and sent by the UE to the BS.

Alternatively or additionally, the RF impairment indication may be determined by the BS. For example, the RF impairment indication may be determined by the BS based on a frequency carrier and/or a bandwidth used by the UE. For example, as the bandwidth used by the UE increases, the PN experienced by the UE increases as well especially at higher frequency carriers.

The RF impairment indication may indicate a RF impairment class. The RF impairment indication may indicate a RF impairment class either explicitly or implicitly. That is, the RF impairment indication may convey the RF impairment class as such or may convey information to derive the RF impairment class (as will be apparent further below). In an example, the RF impairment class comprises class 1, class 2 and class 3.

It will be understood that the term “class” is to be interpreted broadly and may for example be interchanged with the term “level”, “category” or “group”. That is, the impairment indication may explicitly indicate a level of impairment, a category of impairment or a group of impairment.

The RF impairment class may be assigned to a UE based on a severity of one or more RF impairment(s). In an example, class 1 refers to a high RF impairment(s), class 2 refers to a medium RF impairment(s) and class 3 refers to low RF impairment(s).

The RF impairment class may be assigned to a UE based on a dominant type of the RF impairment. In an example, class 1 refers to a PN impairment, class 2 refers to a quantization impairment, class 3 refers to an in phase and quadrature imbalance impairment.

The RF impairment class may be assigned to a UE based on a subtype of the RF impairment. In an example, class 1 refers to a Wiener component being greater than a Gaussian component, class 2 refers to a Gaussian component being greater than a Wiener component and class 3 refers to a Gaussian component being substantially equal to a Wiener component (i.e. the difference between the Gaussian component and the Wiener component is lower than a difference threshold).

In another example, class 1 refers to a resolution of an analogue to digital converter being lower than a threshold, class 2 refers to a resolution of an analogue to digital converter being substantially equal to a threshold and class 3 refers to a resolution of an analogue to digital converter being greater than a threshold.

In another example, class 1 refers to an in phase and quadrature imbalance being lower than a threshold, class 2 refers to a in phase and quadrature imbalance being substantially equal to a threshold and class 3 refers to a in phase and quadrature imbalance being greater than a threshold.

The greater the bandwidth allocated to the UE may be, the greater the Gaussian component may be compared to the Wiener component. The lower the bandwidth allocated to the user equipment may be, the greater the Wiener component may be compared to the Gaussian component.

As explained above, the RF impairment indication may indicate a RF impairment class implicitly. That is, the BS may derive the RF impairment class from the RF impairment indication. The RF impairment indication may comprise a desired RS configuration indication. In other words, the RF impairment class may be implicitly indicated via a desired RS configuration indication. The desired RS configuration may comprise a desired PT-RS configuration and/or a desired DMRS configuration. The BS may derive a RF impairment class assigned to the UE based on the desired RS configuration indication.

In another example, the RF impairment indication may comprise a quality of a local oscillator at the UE. In other words, the RF impairment class may be implicitly indicated via a quality of a local oscillator at the UE. The BS may derive a RF impairment class assigned to the UE based on the quality of a local oscillator at the UE.

In another example, the RF impairment indication may comprise a resolution of an analogue to digital converter at the UE. In other words, the RF impairment class may be implicitly indicated via a resolution of an analogue to digital converter at the UE. The BS may derive a RF impairment class assigned to the UE based on the resolution of an analogue to digital converter at the UE.

In another example, the RF impairment indication may comprise a physical random access channel preamble used by the UE in an initial access phase. In other words, the RF impairment class may be implicitly indicated via a physical random access channel preamble used by the UE in an initial access phase. The BS may derive a RF impairment class assigned to the UE based on the physical random access channel preamble used by the UE in an initial access phase.

It will be understood that the RF impairment class may be implicitly indicated via numerous manners, for example by using specific PRACH configuration (preambles/formats/sequences length/number of preamble repetitions/ . . . ), by sending a UE request for specific configuration (RS density/pattern, AL, . . . ), by tying some RF impairments to specific configurations in general (e.g., MIMO in sub-THz->low ADC, wideband at high carrier frequencies->high PN, . . . ), by indicating UE capabilities and/or level/range of one or more RF impairments and/or dominant RF impairment type/sub-type. All these indications could implicitly mean a specific RF impairment class that requires specific configuration.

The RF impairment indication may be specific to at least one of a bandwidth, a SCS or a frequency carrier used by the UE. That is, the BS may receive a RF impairment indication for a bandwidth or a SCS and/or frequency carrier used by the UE and another RF impairment indication for another bandwidth or another SCS and/or frequency carrier used by the UE.

The BS may define the PDCCH configuration based on the RF impairment indication. The BS may define the PDCCH configuration within a PDCCH search space. The PDCCH search space may be known by the UE.

Defining the PDCCH configuration may comprise defining at least one of a CCE configuration, a RS configuration, a SCS configuration, an AL configuration, a REG configuration, a REG bundle configuration, a modulation scheme (MCS) configuration, or a code rate configuration.

Defining a CCE configuration may comprise defining a CCE configuration per block or per multiple blocks. Defining a CCE configuration may comprise defining a number of REGs per CCE. Defining a CCE configuration may comprise defining a CCE pattern. Defining a pattern may comprise defining a partially contiguous pattern wherein the CCEs are conveyed over contiguous blocks or a partially non-contiguous pattern wherein the CCEs are conveyed over non-contiguous blocks. A pattern may be partially contiguous and partially non-contiguous, that is, some CCEs may be conveyed over contiguous blocks and other CCEs may be conveyed over non-contiguous blocks.

A block may convey a set of modulation symbols that may be prepended with a cyclic prefix and sent to the UE in the time domain as illustrated on FIGS. 4 to 6. Each modulation symbol may be conveyed by a set of samples. A block may be a (KT) DFT-s-OFDM block, a SC-FDE block, a SC-TDE block or a CP-OFDM block. The cyclic prefix may comprise a determined pattern. The cyclic prefix may comprise a unique word, zero padding or other.

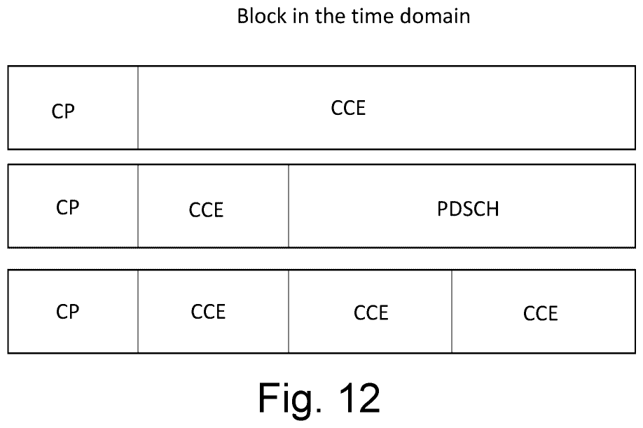

FIG. 12 shows different CCE configurations when the PDCCH is sent using a single-carrier waveform provided by a (KT) DFT-s-OFDM system, SC-FDE system or SC-TDE system. In a first configuration, a single CCE may be conveyed in an entire block. In a second configuration, a single CCE may be conveyed in a portion of a block. A PDSCH may be conveyed in another portion of the block. In a third configuration, multiple CCEs may be conveyed in an entire block. In the first configuration, the second configuration and the third configuration a single CCE may spread over a single OFDM symbol or over multiple OFDM symbols.

Defining a RS configuration may comprise defining a PT-RS configuration and/or defining a DMRS configuration.

Defining a RS configuration may comprise defining a RS configuration per CCE, per multiple CCEs, per REG, per multiple REGs, per block or per multiple blocks.

Defining a RS configuration may comprise defining a number of RS symbols. An RS symbol may mean a known modulation symbol. Defining a number of RS symbols may comprise defining a number of RS symbols in the time domain (i.e. time density) or in the frequency domain (i.e. frequency density).

Defining a RS configuration may comprise defining a pattern of the RS symbols. Defining a pattern of the RS symbols may comprise defining a pattern of the RS symbols over a single or multiple OFDM or single-carrier symbols or blocks. Defining a pattern of the RS symbols may comprise defining a contiguous pattern wherein the RS symbols span over multiple contiguous blocks. Defining a pattern of the RS symbols may comprise defining a non-contiguous pattern wherein the reference signal symbols span over multiple non-contiguous blocks. A pattern may be partially contiguous and partially non-contiguous, that is, some RS symbols may be conveyed over contiguous blocks and other RS symbols may be conveyed over non-contiguous blocks.

Defining a RS configuration may comprise defining a transmission power of the RS symbols.

Defining the RS configuration may be based on an AL used for PDCCH. The lower the AL may be, the higher the overhead of RS symbols may be (if the coding rate is increased with the lower AL). The lower the AL may be, the higher the transmission power of the RS symbols may be.

Defining the RS configuration may be based on a coding rate used for PDCCH. The higher the coding rate may be, the higher the number of RS symbols may be.

Defining the RS configuration may be based on a modulation scheme used for PDCCH. The higher the modulation scheme may be, the higher the overhead of RS symbols may be.

Defining the RS configuration may be based on the waveform used for sending the PDCCH to the UE. That is, the BS may define a RS configuration when the BS uses a single-carrier waveform to send the PDCCH to the UE and another RS configuration when the BS uses a multiple-carrier waveform to send the PDCCH to the UE.

Defining a PDCCH configuration may comprise defining a SCS configuration. It will be understood that defining a SCS configuration applies to a CP-OFDM system and a (KT) DFT-s-OFDM system but not to a SC-FDE system.

Defining a PDCCH configuration may comprise defining a coding rate. The coding rate may be adjusted based on a PT-RS configuration.

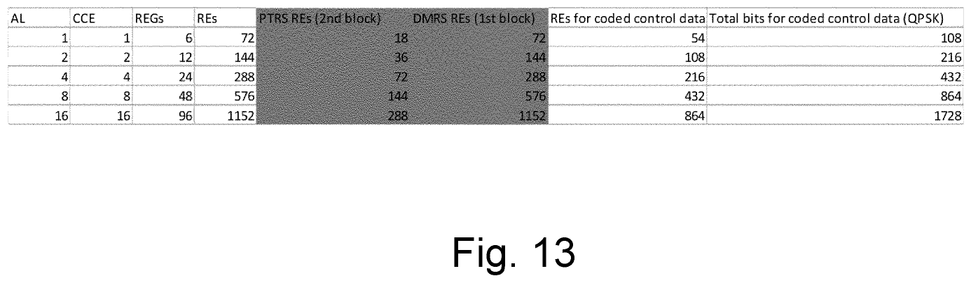

FIG. 13 shows an example table specifying the relationship between an AL level, a number of CCEs, a number of REGs, a number of REs, a number of PT-RS REs, a number of DMRS REs, a number of coded control data (i.e. DCI) REs and a total number of bits for the coded control data (i.e. DCI).

The BS may send the PDCCH based on the PDCCH configuration. The BS may use a single-carrier waveform or using a multiple carrier waveform. The single-carrier waveform may be provided by a (KT) DFT-s-OFDM system, a SC-FDE system or SC-TDE system. The multiple-carrier waveform may be provided by a CP-OFDM waveform.

The BS may determine a PDCCH configuration based on the RF impairment indication. The UE may receive the PDCCH configuration from the BS, or network in general (e.g. in a system information block or dedicated RRC signalling or other signalling methods). Alternatively, the UE may determine a PDCCH configuration based on the RF impairment indication. The UE may receive the PDCCH from the BS with the PDCCH configuration determined based on the RF impairment indication.

The above aspects may be combined in all possible manners to design all possible implementations. Several implementations are discussed by way of example only.

In an implementation, when the RF impairment indication indicates a certain RF impairment class, the BS may define a DMRS configuration so that the DMRS symbols are conveyed in multiple blocks and a number of DMRS symbols per CCE, per REG or per block is greater than a number threshold. In this way, the channel may be estimated reliably.

In an implementation, when the RF impairment indication indicates a certain RF impairment class, the BS may define a minimum SCS, a DMRS pattern and a PT-RS pattern.

In an implementation, when the RF impairment indication indicates a certain RF impairment class, the BS may define a DMRS pattern and a PT-RS pattern.

In an implementation, when the RF impairment indication indicates a certain RF impairment class, the BS may define a PT-RS configuration so that a number of PT-RS symbols per CCE, per REG or per block is greater than a number threshold.

In an implementation, when the RF impairment indication indicates a certain RF impairment class, each CCE may comprise 18 DMRS REs. Each CCE may be conveyed over two blocks. Each CCE may comprise 12 REGs.

In an implementation, when the RF impairment indication indicates a certain RF impairment, each PTRS pattern may be conveyed over multiple CCEs or multiple REGs. In this implementation, the UE may optimize the phase noise efficiently from PTRS symbols jointly over multiple CCEs or REGs

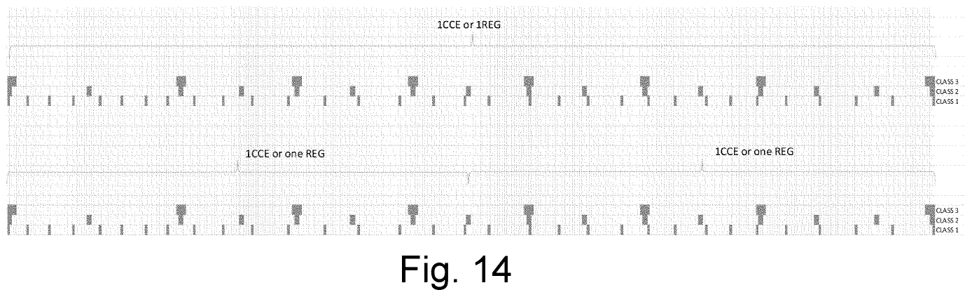

FIG. 14 shows different PT-RS configurations based on the class associated to the UE. Each row may represent one or more time-domain single-carrier symbols (e.g., a DFT-s-OFDM symbol or KT-DFT-s-OFDM symbol), time-domain blocks, CCEs or REGs. In this example figure, each row represents e.g., a CCE or REG in the upper figure or multiple of those in the lower figure, and a row can be referred to as a block in both figures. The block may convey one or more CCEs comprising PT-RS symbols (shaded cells). The number of PT-RS symbols per CCE may be the same when the UE is associated to class 1, class 2 or class 3. That is, the PT-RS overhead per CCE is the same when the UE is associated to class 1, class 2 or class 3. Alternatively, the number of PT-RS symbols per CCE may be different when the UE is associated to class 1, class 2 or class 3. That is, the PT-RS overhead per CCE is different when the UE is associated to class 1, class 2 or class 3.

The BS may define a PT-RS configuration with a first pattern and a first number of PT-RS symbols when the UE is associated with the class 1. The first pattern may comprise a non-contiguous pattern wherein PT-RS symbols may be conveyed over non-contiguous blocks.

The BS may define a PT-RS configuration with a second pattern and a second number of PT-RS symbols wen the UE is associated with the class 2. The second pattern may comprise a partially contiguous/partially non-contiguous pattern wherein some PT-RS symbols may be conveyed over contiguous blocks and some PT-RS symbols may be conveyed over non-contiguous blocks. The second number of PT-RS symbols may be the same or lower than the first number of PT-RS symbols.

The BS may define a PT-RS configuration with a third pattern and a third number of PT-RS symbols when the UE is associated with the class 3. The third pattern may comprise a partially contiguous/partially non-contiguous pattern wherein some PT-RS symbols may be conveyed over contiguous blocks and some PT-RS symbols may be conveyed over non-contiguous blocks. The third number of PT-RS symbols may be the same or lower than the second number of PT-RS symbols.

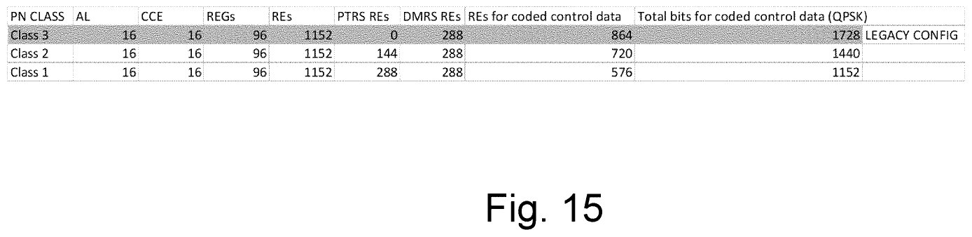

FIG. 15 shows different PT-RS configurations based on the class associated to the UE. The number of PT-RS symbols per CCE may be different when the UE is associated to class 1, class 2 or class 3. That is, the PT-RS overhead per CCE is different when the UE is associated to class 1, class 2 or class 3.

The BS may define a PT-RS configuration with a first number of PT-RS symbols per CCE when the UE is associated with the class 1 and a first code rate. The BS may define a PT-RS configuration with a second number of PT-RS symbols per CCE and a second code rate when the UE is associated with the class 2. The BS may define a PT-RS configuration with a third number of PT-RS symbols per CCE and a third code rate when the UE is associated with the class 3. The first number of PT-RS symbols per CCE may be greater than the second number of PT-RS symbols per CCE. The second number of PT-RS symbols per CCE may be greater than the third number of PT-RS symbols per CCE. The first code rate may be larger than the second code rate. The second code rate may be larger than the third coded rate.

It will be understood that in FIG. 15 the last column is the number of bits available for coded data. However, if the same amount of actual information is to be transmitted in different cases, the coding rate may have to be larger if more PT-RS symbols are used.

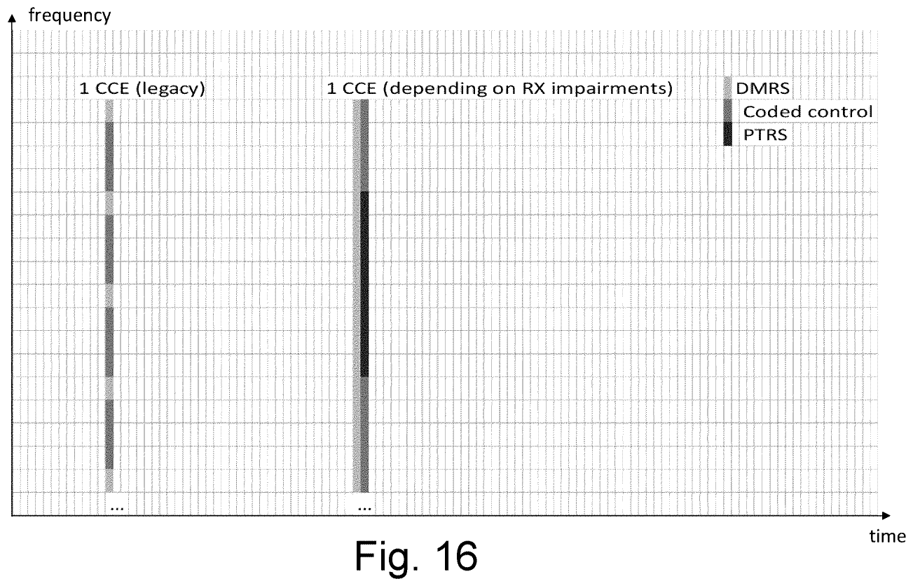

FIG. 16 shows an example PT-RS and DMRS configuration for a CCE occupying two OFDM symbols. Each column may represent an OFDM symbol. Each cell may represent a RE. Each CCE may be conveyed over two contiguous blocks. Each CCE may comprise DMRS symbols conveyed over a first block. Each CCE may comprise coded control data (i.e. DCI) symbols conveyed over a second block. Each CCE may comprise PT-RS conveyed over the second blocks. The PT-RS configuration may be dependent on the RF impairment indication received from the UE. The PT-RS configuration may be dependent on the SCS used by the UE.

A first example CCE including a DMRS configuration according to a legacy system is illustrated on the left-hand side, wherein the DM-RS symbols may be conveyed in a single OFDM symbol in distributed manner. According to embodiments this DM-RS (or alternatively PT-RS) configuration may depend on the RF impairments, and may enable efficient PN compensation for certain UEs.

A second example involving CCE defined over two OFDM symbols with respectively optimized PT-RS configuration over the CCE is illustrated on the right-hand side where DMRS symbols occupies the first OFDM symbol of the CCE and the PT-RS symbols may be conveyed in a second OFDM symbols of the CCE (e.g. in a block-wise manner in this example). Similarly these configurations may depend on the RF impairments and control data may be also included in the first block. In the examples, a CCE can be also replaced by a REG, a number of REGs or a number of CCEs.

In an implementation, when the RF impairment indication indicates a certain RF impairment class, the CCE configuration may be the same as in a legacy 5GS but the DMRS configuration and the code rate configuration may be different. The number of DMRS symbols may be increased. The code rate for the coded control data (i.e. DCI) may be increased or decreased.

In an implementation, when the RF impairment indication indicates a certain RF impairment class, each CCE may be conveyed by a single block. The number of PT-RS symbols may be increased. The code rate for the coded control data (i.e. DCI) may be increased or decreased.

In an implementation, when the RF impairment indication indicates a certain RF impairment class, each CCE may be conveyed in a single block. The number of DMRS symbols may be increased. The code rate for the coded control data (i.e. DCI) may be increased or decreased.

In an implementation, when the RF impairment indication indicates a certain RF impairment class, each CCE may be conveyed in two blocks. DMRS symbols may be conveyed in a first block. PT-RS symbols and control data (i.e. DCI) symbols may be conveyed in a second block. The code rate for the control data may remain unchanged.

In an implementation, when the RF impairment indication indicates a certain RF impairment class, each CCE may be conveyed in two or more blocks. DMRS symbols may be conveyed in a block. PT-RS symbols and control data (i.e. DCI) symbols may be conveyed in the same block or in another block. The code rate for the control data may be increased or decreased.

One or more aspects of this disclosure is advantageous in that it allows UEs experiencing various RF impairments to receive the PDCCH sent from the BS reliably.

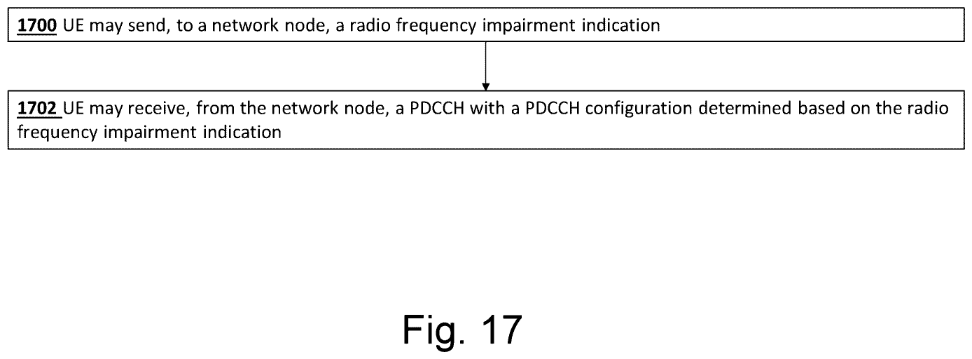

FIG. 17 shows a block diagram of a method for receiving a PDCCH performed by a UE.

In step 1700, the UE may send, to a network node, a RF impairment indication.

In step 1702, the UE may receive, from the network node, a PDCCH with (i.e. configured with) a PDCCH configuration determined based on the RF impairment indication.

The UE may monitor, a PDCCH with a PDCCH configuration determined based on the RF impairment indication. Alternatively, The UE may blindly monitor, a PDCCH with different PDCCH configurations.

The network node may be a BS.

The RF impairment indication may explicitly indicate a RF impairment class.

The RF impairment indication may depend on a severity of a RF impairment. The severity of a RF impairment at the UE may comprise at least one of: a high RF impairment; a medium RF impairment; or a low RF impairment.

The RF impairment indication may depend on a type of a RF impairment. The type of a RF impairment at the UE may comprise at least one of: a phase noise impairment; a quantization impairment; a in phase and quadrature imbalance impairment; a power amplifier non-linearity, a time jitter; or a carrier frequency offset.

The RF impairment indication may depend on a subtype of a RF impairment at the UE.

The RF impairment indication may implicitly indicate a RF impairment class assigned to the UE. The RF impairment indication may comprise at least one of: a desired RS configuration by the UE; a quality of a local oscillator at the UE; a resolution of an analogue to digital converter at the UE; or a PRACH preamble used by the UE in an initial access phase.

The RF impairment indication may be sent via at least one of: capability information signaling; physical random access channel signaling; or radio resource control signaling.

The desired reference signal configuration may comprise a desired PT-RS configuration.

The RF impairment indication may be specific to at least one of a bandwidth, a SCS or a frequency carrier used by the UE.

Determining the PDCCH configuration by the UE may comprise determining at least one of: a RS configuration; a SCS spacing configuration; an AL configuration; a CCE configuration; a REG configuration; a REG bundle configuration; a MCS configuration; or a code rate configuration.

The RS configuration may comprise a number of RS symbols.

Determining the RS configuration may comprise determining at least one of: a pattern of the RS symbols; or a transmission power of the RS symbols.

Determining the pattern of the RS symbols may comprise: determining a contiguous pattern wherein the RS symbols span over multiple contiguous blocks; or determining a non-contiguous pattern wherein the RS symbols span over multiple non-contiguous blocks.

Determining the RS configuration may comprise determining the RS configuration over: a CCE or multiple CCEs; a REG or multiple REGs; or a block or multiple blocks.

Determining the RS configuration may comprise determining at least one of: a PT-RS configuration; or a DMRS configuration.

Determining the RS configuration may be based on at least one of: an AL used by the UE; a coding rate used by the UE; or a waveform used for sending the PDCCH by the UE.

The lower the AL may be, the higher the overhead of RS symbols may be (if the coding rate is increased with the lower AL).

The lower the AL may be, the higher the transmission power of the RS symbols may be.

The waveform used for sending the PDCCH may comprise a single-carrier waveform or a multiple-carrier waveform.

A single-carrier waveform may be provided by at least one of: a DFT-s-OFDM system; a (KT) DFT-S-OFDM system; a SC-FDE system or a SC-TDE system.

A multiple-carrier waveform may be provided by CP-OFDM system.

Determining the AL configuration may comprise determining a minimum AL.

The higher the coding rate (i.e. the lower the AL) may be, the more detrimental the RF impairment may be. Therefore, the AL may be equal to or greater than the minimum AL to mitigate the RF impairment.

The PDCCH configuration may be determined by the UE based on the RF impairment indication; or the PDCCH configuration may be determined by the network node based on the RF impairment indication and received by the UE from the network node.

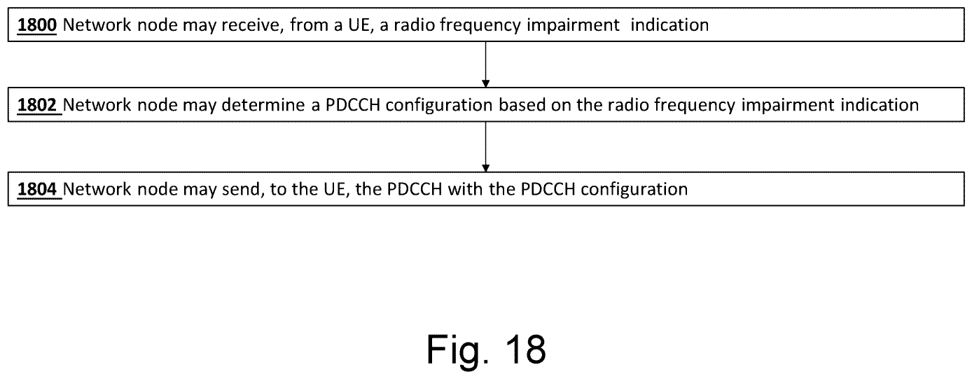

FIG. 18 shows a block diagram of a method for sending a PDCCH performed by a network node.

In step 1800, the network node may receive, from a UE, a RF impairment indication.

In step 1802, the network node may determine a PDCCH configuration based on the RF impairment indication.

In step 1804, the network node may send, to the UE, the PDCCH with (i.e. configured with) the PDCCH configuration.

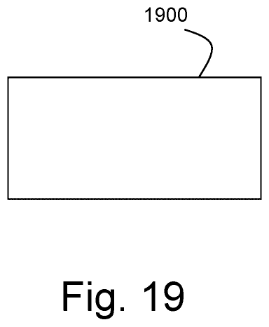

FIG. 19 shows a schematic representation of non-volatile memory media 1900 storing instructions and/or parameters which when executed by a processor allow the processor to perform one or more of the steps of the methods of FIGS. 17 and 18.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 17 and 18, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as configured in the appended claims.

1. An apparatus comprising at least one processor and at least one memory including computer code for one or more programs, the at least one memory and the computer code configured, with the at least one processor, to cause the apparatus at least to:
send, to a network node, a radio frequency impairment indication; and
receive, from the network node, a physical downlink control channel with a physical downlink control channel configuration determined based on the radio frequency impairment indication.

2. The apparatus of claim 1, wherein the radio frequency impairment indication explicitly indicates a radio frequency impairment class.

3. The apparatus of claim 2, wherein the radio frequency impairment indication depends on a severity of a radio frequency impairment.

4. The apparatus of claim 3, wherein the severity of a radio frequency impairment at the apparatus comprises at least one of:
a high radio frequency impairment;
a medium radio frequency impairment; or
a low radio frequency impairment.

5. The apparatus of claim 2, wherein the radio frequency impairment indication depends on a type of a radio frequency impairment.

6. The apparatus of claim 5, wherein the type of a radio frequency impairment at the apparatus comprises at least one of:
a phase noise impairment;
a quantization impairment;
a in phase and quadrature imbalance impairment;
a power amplifier non-linearity,
a time jitter; or
a carrier frequency offset.

7. The apparatus of claim 5, wherein the radio frequency impairment indication depends on a subtype of a radio frequency impairment at the apparatus.

8. The apparatus of claim 1, wherein the radio frequency impairment indication implicitly indicates a radio frequency impairment class assigned to the apparatus.

9. The apparatus of claim 8, wherein the radio frequency impairment indication comprises at least one of:
a desired reference signal configuration by the apparatus;
a quality of a local oscillator at the apparatus;
a resolution of an analogue to digital converter at the apparatus; or
a physical random access channel preamble used by the apparatus in an initial access phase.

10. The apparatus of claim 1, wherein the radio frequency impairment indication is specific to at least one of a bandwidth, a subcarrier spacing or a frequency carrier used by the user equipment.

11. The apparatus of claim 1, wherein determining the physical downlink control channel configuration by the apparatus comprises determining at least one of:
a reference signal configuration;
a subcarrier spacing configuration;
an aggregation level configuration;
a control channel element configuration;
a resource element group configuration;
a resource element group bundle configuration;
a modulation scheme configuration; or
a code rate configuration.

12. The apparatus of claim 11, wherein the reference signal configuration comprises a number of reference signal symbols.

13. The apparatus of claim 11, wherein determining the reference signal configuration comprises determining at least one of:
a pattern of the reference signal symbols; or
a transmission power of the reference signal symbols.

14. The apparatus of claim 13, wherein determining the pattern of the reference signal symbols comprises:
determining a contiguous pattern wherein the reference signal symbols span over multiple contiguous blocks; or
determining a non-contiguous pattern wherein the reference signal symbols span over multiple non-contiguous blocks.

15. The apparatus of claim 11, wherein determining the reference signal configuration comprises determining the reference signal configuration over:
a control channel element or multiple control channel elements;
a resource element group or multiple resource element groups; or
a block or multiple blocks.

16. The apparatus of claim 11, wherein determining the reference signal configuration comprises determining at least one of:
a phase tracking reference signal configuration; or
a demodulation reference signal configuration.

17. The apparatus of claim 11, wherein determining the reference signal configuration is based on at least one of:
an aggregation level used by the apparatus;
a coding rate used by the apparatus; or
a waveform used for sending the physical downlink control channel by the apparatus.

18. The apparatus of claim 11, wherein determining the aggregation level configuration comprises determining a minimum aggregation level.

19. The apparatus of claim 1, wherein the physical downlink control channel configuration is determined by the apparatus based on the radio frequency impairment indication; or
wherein the physical downlink control channel configuration is determined by the network node based on the radio frequency impairment indication and received by the apparatus from the network node.

20. (canceled)

21. A method comprising:
sending, to a network node, a radio frequency impairment indication; and
receiving, from the network node, a physical downlink control channel with a physical downlink control channel configuration determined based on the radio frequency impairment indication.

22-23. (canceled)
